(19) United States
(12) Patent Application Publication
(10) Pub. No.: US 2004/0215490 A1
(43) Pub. Date: Oct. 28, 2004

(54) Integrated medical information management and medical device control system and method

(76) Inventors: Douglas J. Duchon, Chanhassen, MN (US); Robert F. Wilson, Roseville, MN (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/848,458

(22) Filed: May 18, 2004

Related U.S. Application Data
(63) Continuation of application No. 09/540,358, filed on Mar. 31, 2000, now abandoned.
(60) Provisional application No. 60/127,436, filed on Apr. 1, 1999.

(51) Int. Cl. G06F 17/60

(52) U.S. Cl. 705/2

(57) ABSTRACT

An integrated medical information management and medical device control system and method are described that links multiple users and multiple medical devices together in a coordinated fashion. The linkage of users and medical devices is accomplished using a bi-directional network and a centralized host system. Users of the system are able to communicate with each other, operate medical devices from remote locations, access information from diverse sources automatically monitor a patent's status.

### FIELD OF THE INVENTION

The present invention is related to a medical information management and medical device control system that uses a bi-directional network communication system to coordinate multiple data input sources, provides access to the World Wide Web, and communicates with third parties while using medical devices. Specifically, the present invention relates to the use of the Internet and the World Wide Web to receive and store operational parameters of selected medical devices, patient diagnostic data, and other vital medical information from remote sites. Moreover, the present invention can be used to access the World Wide Web, exchange information between consultants and operators and coordinate the functions of medical devices.

### BACKGROUND OF THE INVENTION

Technology at the dawn of the twenty-first century has reached a complexity level unimagined just twenty years ago. Nearly every aspect of our daily life has been affected by microprocessors, computers and computer assisted devices. The impact this technology has had on business and society as is especially evident by the Internet's rapid expansion and the increased role computers are playing in the physical and biological sciences. The benefit these technologies have brought to human kind are enormous and are especially apparent in the field of medicine and healthcare.

However, there are also many adverse consequences associated with the recent technology expansion. As the speed and capacity of computer processors increase, software engineers are continually improving their products to keep pace with the hardware. Consequently, new hardware and their related software is becoming increasing complex creating a “technology overload” for the consumer. The average technology user has great difficulty in maximizing the newer computers' potential and much of their capacity remains unrealized. This “technology overload” can be further exacerbated when the software is imbedded in an already complex machine requiring the operator to master both the devices' mechanical aspects and its software-based operating system. Moreover, when more than one of these complex machines are used simultaneously, the complexity level increases exponentially.

Medicine is one of the most technically demanding scientific disciplines. Rapid advancements in medical technology have provided physicians and patients with life saving options that were unavailable five years ago. Moreover, technical advances have significantly improved the life quality for millions of persons previously destined to joyless, painful existences. However, the full potential of these recent technical advances remains unrealized, limited by the ability of the user to coordinate, interface and operate a diverse assembly of complex medical devices and their associated software based operating systems.

One of the most significant technical advances of the last one hundred years is the development and proliferation of the Internet. The Internet's emergence has provided the world with convenient access to a plethora of information. Regardless of the subject matter or level of detail required, it can be found on the World Wide Web (Web). The popularity and accessibility of the Internet has resulted in many companies putting new product information and technical releases on their Internet home page long before hard copies are available. Therefore, in order to remain on the cutting edge of any profession, especially dynamic technical fields like medicine, it is essential to have ready access to the Internet. However, as with the “technology explosion” described above, the “information explosion” the Internet has facilitated often adds to life's technical complexity rather than simplifying it. Consequently, the Internet, like the recent hardware and software advances often remains under utilized.

The Internet and recent advances in the medical sciences could be combined synergistically to help realize the full potential of both technologies. For example, an Internet Web site could be used to coordinate the functions of multiple medical devices, facilitate the rapid exchange of information between medical professions, provide for remote device command and control capabilities and collate patient statistics. The greatest difficulty in achieving such a synergistic system is the lack of compatibility between various medical devices. Medical devices generally have proprietary operating systems that limit their ability to use data generated by other sources. However, using the Internet, communication between theses these diverse operating systems and data sources could be established through a medical information management and medical device control system that has been designed to interpret, translate and process data from nearly any conceivable source. As a result, a seamless interface could be established that would allow the medical device operator to instantly access device operating parameters, current patient status data, technical resources and personal preferences.

Moreover, such a Web site could be used to provide the medical device operator access to consultants during the performance of a medical procedure. The consultants would have simultaneous access to the same patient statistics and system data that the attending operator has. Real time consultations could occur without geographical limitations putting the world's experts at the bedside of every patient in need. Furthermore, the medical device operator could access Internet Web sites to obtain up-to-date technical information without leaving the patient's side. The patient could be located in the field, an ambulance, an emergency room, a coronary care catheter laboratory, or the sterile field of a surgical suite.

Yet even further, the device operator could gain access to interactive teaching information so that the user can become easily educated on the operation and maintenance device. Also, the device manufacturer could provide updated software and preventative maintenance information to the device without having to physically access the device.

Consequently, a Web site integrating medical devices, consultants, administrators, patient vital statistics, and technical facts would greatly assist hospitals and physicians save lives, reduce suffering, spare valuable economical resources and advance the education of thousands of healthcare practitioners world wide.

### SUMMARY OF THE INVENTION

It is an object of the present invention to provide a medical information management and medical device control system that receives, stores, and provides access to important patient statistics, medical device operational parameters and operator preferences related to performing medical procedures.

It is another object of the present invention to provide a medical information management and medical device control system that utilizes a bi-directional network to transmit and receive patient statistics, medical device operational parameters and operator preferences related to performing medical procedures.

It is still another object of the present invention to provide an Internet Web Site that processes and stores patient statistics, clinical data, imaging data, procedural indications, medical device operational parameters and operator preferences related to performing medical procedures received from multiple remote locations.

It is yet another object of the present invention to provide an Internet Web site that can coordinate and interface a number of different medical devices simultaneously.

It is another object of the present invention to provide an Internet Web site that an operator can accessed from a remote site and, through the Internet Web site, control and command the medical device.

It is yet another object of the present invention to provide an Internet Web site whereby an operator can contact a consultant who, through the Web site of the present invention, has simultaneous access to the same patient vital statistics, clinical data, imaging data, medical device operational parameters and operator preferences related to performing medical procedures available to the operator of the medical device. Further, the scope and particulars of the data transmitted to the consultant can be limited automatically using pre-stored or user defined parameters to protect confidentiality.

It is still another object of the present invention to provide an Internet Web site that allows the operator to search the contents of other Internet Web sites while continuing to perform the medical procedure. Further, the operator would be able to simultaneously contact one or more consultants using the Internet, Intranet, telephone or a combination of the communication pathways.

It is another object of the present invention to provide an Internet Web site that interfaces with a hospital or other healthcare provider's administrative systems to assist with providing information management and control over medical devices and procedures.

The medical information management and medical device control system of the present invention has a bi-directional network to coordinate multiple data input sources, provide access to the World Wide Web (“the Web”), and communicate with third parties while using medical devices. The preferred embodiment of the present invention uses the Internet as the bi-directional network to access the Web. A dedicated Web site that receives, processes, stores and transmits information related to medical procedures is located within the host system. The host system is generally referred to as a server, but may be any computer or other device capable of receiving, processing and transmitting information. The information transmitted and received by the present invention includes, but is not limited to, medical device operational parameters, personal system preferences, technical updates, research articles, patient vital signs, medication schedules, diagnostics, service requirements, laboratory results, patient histories, procedure reports, equipment inventor, imaging date (e.g. x-ray, angiography, magnetic resonance imaging), third party payor information and e-mail (collectively referred to hereinafter as the “information”).

The information management system of the present invention is composed of at least one remote transmitting appliance for sending information to a Web site and a remote receiving appliance for accepting information from a Web site. In one embodiment of the present invention the remote transmitting appliance is co-located with the remote-receiving appliance. In another embodiment of the present invention the remote transmitting appliance is integrated into a device which does not act as a receiving appliance. Third is an independent device that operates in a sterile field environment using a user interface that preserves the sterility of the user, e.g., an infrared device, a touchscreen with a sterile cover.

The Web site of the present invention has a communication interface for receiving information from each remote transmitting appliance and database for processing and storing the information. The Web site of the present invention also has a bi-directional network connecting the remote transmitting appliances, the remote receiving appliances and the Web site together. This bi-directional network facilitates the exchange of information between the Web site, the remote-transmitting appliances and the remote-receiving appliances.

The bi-directional network of the present invention has at least one remotely located transmitting and receiving appliance. The remote transmitting and receiving appliances of the present invention may have an information display and input means. Non-limiting examples of remotely located transmitting and receiving means of the present invention include computer terminals, devices for monitoring patient status, diagnostic devices, portable electronic devices, telephones, and radio transmitters. Non-limiting examples of information display means include video monitors, light signals, Teletype printouts, Braille printouts, and audible broadcasts. Information input means include, but are not limited to, keyboards, joy sticks, touch sensitive video screens, bar code reader, push buttons, switches, key punch cards, and microphones.

Another aspect of the present invention permits the operator to share patient statistics, clinical data, imaging data and medical device operating information with a consultant or other individual. For example, an invited consultant can access the Web site via a remote transmitting and receiving means and directly participate in treating a patient or operating the medical device. Using the Web site of the present invention, the consultant can view vital patient statistics including, but not limited to, laboratory data, medications, and video images of diagnostic tests such as angiograms.

In yet another embodiment of the present invention the bi-directional network can provide access to operation and control of a medical device through a remote transmitting and receiving appliance. In this embodiment, the actual medical procedure, or portions thereof, can be monitored and conducted at a remote site.

In still another embodiment of the present invention, the medical information and management system can be used to assess potential outcomes of medical procedures based on statistical probabilities. Algorithms stored in databases are combined with patient vital signs to assist the operator in medical procedure selection. Moreover, the same databases can alert an operator in advance of a life-threatening event, or if necessary, abort the procedure automatically.

Another embodiment of the present invention is a method of managing medical information and controlling medical devices by providing a World Wide Web site that has a communication interface and a plurality of user accessible databases. The databases include information related to coordinating and operating multiple, diverse medical devices that can be used simultaneously in the treatment or diagnosis of a patient. Additional databases include, but are not limited to, technical information pertaining to the operation and maintenance of a medical device and user profile information including patient statistics, user preferences, available consultants, and algorithms for risk management.

The method of the present invention is also used to receive medical information and medical device operating instructions through the communications interface and to store medical information and medical device operating instructions in its databases. Moreover, medical information and medical device operating instructions and other information can be requested by a plurality of uses either individually or simultaneously. The medical information, medical device operating instructions and other requested information is then extracted from the databases of the present invention and transmitted to the healthcare worker treating the patient and/or a direct operator of a medical device. As a result, a plurality of medical devices can be coordinated simultaneously using the communication interface and databases of the World Wide Web site in accordance with the teachings of the present invention.

As a result of the complexity of the present invention, each element and feature is presented separately. However, it is understood that each element would be combined with other, or all, of the elements into an interactive, integrated system designed to maximize the potential of each element, and through synergy, create medical information management and medical device control system that provides benefits greater than the sum of its parts. Furthermore, while the maximum versatility of the present invention will be realized using the Internet as the bi-directional network, it is also possible to create the integrated medical information management and medical device control system of the present invention using an Intranet. In some applications Intranets may be preferred do to the higher level of security and confidentiality that can be maintained. It is also possible to “hard-wire” all of the devices of the present invention together and avoid using telecommunication devices altogether. However, hard-wired systems are more expensive to install and less versatile than either Internet or Intranet based systems.

Additional objects and advantages of the present invention and methods of construction of same will become readily apparent to those skilled in the art from the following detailed description, wherein only the preferred embodiments are shown and described, simply by way of illustration of the best mode contemplated of carrying out the invention. As will be realized, the invention is capable of modification in various respects, all without departing from the invention. Accordingly, the drawings and description are to be regarded as illustrative in nature, and not as restrictive.

### BRIEF DESCRIPTION OF THE DRAWINGS

A detailed description of the invention is hereafter described by non-limiting examples with specific reference being made to the drawings in which:

FIG. 1 is a block diagram that depicts the basic elements of the integrated medical information management and medical device control system in accordance with a preferred embodiment of the present invention;

FIG. 2 is a block diagram that depicts additional elements of the basic integrated medical information management and medical device control system in accordance with a preferred embodiment of the present invention;

FIG. 3 depicts a bi-directional network communication system coordinating the association of multiple remote-transmitting appliances and remote-receiving appliances with the integrated medical information management and medical device control system in accordance with a preferred embodiment of the present invention;

FIG. 4 is a block diagram that depicts additional elements of the user profile database in accordance with a preferred embodiment of the present invention;

FIG. 5 is a diagram that depicts the interfacing of multiple medical devices and users in accordance with a preferred embodiment of the present invention.

FIG. 6 is a block diagram of a parallel data management aspect of an embodiment of the present invention.

FIG. 7 is a block diagram of a segment of the parallel data management system as shown in FIG. 6.

### DETAILED DESCRIPTION OF THE INVENTION

The present invention is an integrated medical information management and medical device control system incorporating a bi-directional network that facilitates the exchange of information and relays instructions between at least one transmitting appliance and at least one receiving appliance. Examples are generally described in co-pending provisional application U.S. Serial No. 60/127,436, the contents of which are hereby incorporated by reference. In one embodiment of the present invention the bi-directional network allows a diverse group of medical devices and computer terminals to exchange data between one another and provides their operators with remote command and control capabilities. In another embodiment of the present invention the bi-directional network provides operators with a means to communicate directly with each other and share information with remote transmitting and receiving appliances.

In a preferred embodiment of the present invention the integrated medical information management and medical device control system is a World Wide Web site (Web site). The Web site of the present invention is located within a distant computer referred to as the host system, or server. The host system is usually a computer including, but not limited to, UNIX-based windows/DOS systems, NT-based computers, Linux based computers, and Macintosh computers. The preferred bi-directional network of the present invention is the Internet. Hence, the user can be located at any place where there is access to the Internet, including in the sterile filed of the operating room or even at a remote location where access is through a cellular telephone. However, it is understood that secure Intranets and hard-wired systems can also be used to provide access to the integrated medical information management and medical device control system of the present invention. Generally speaking, Intranets are more limiting in scope and versatility, and hard wiring is often even more limiting and usually much more expensive. Moreover, a private database housed in a computer that is isolated from the Internet could substitute for a Web site as the integrated medical information management and medical device control system of the present invention. However, such an isolated system would significantly restrict user access and unnecessarily limit the present invention's versatility. Therefore, for the remainder of this Description of the Invention, a Web site accessed through the Internet is the preferred embodiment.

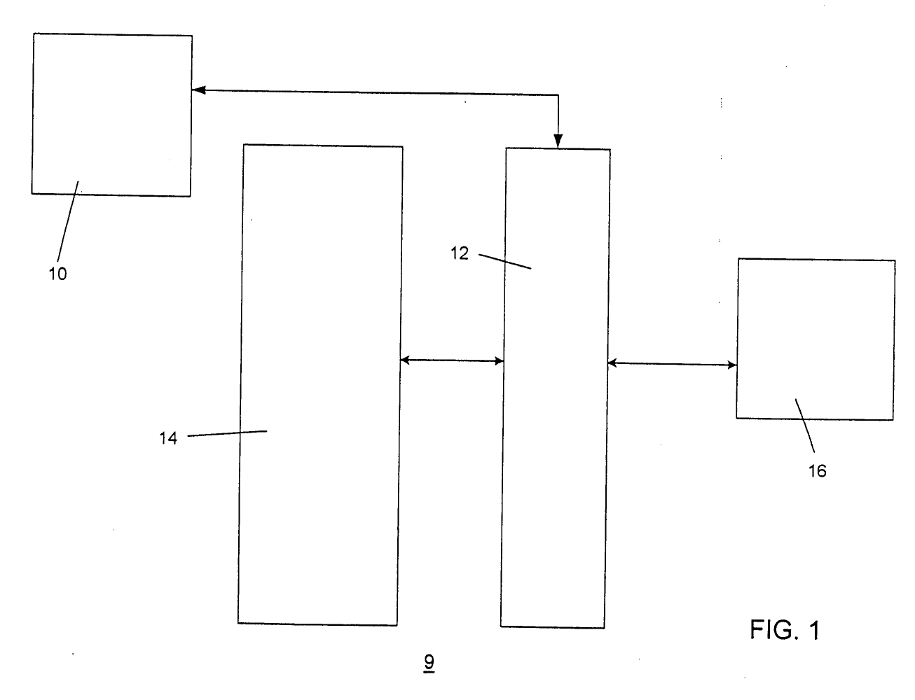

Turning now to FIG. 1, the integrated medical information management and medical device control system 9 of the present invention is depicted. A host communications interface 10 is shown that serves as the first point of contact between the bi-directional network (the Internet) and the integrated medical information management and medical device control system (the Web site). The host communications interface 10 translates data, requests, medical information and medical device operating instructions (hereinafter referred to collectively as “information”) received from diverse transmitting appliances into a standardized format. From the host communications interface 10, the standardized information is sent to a database management system 12 that coordinates the flow of information to and from the centralized database 14. Information extracted from the centralized database 14 is sent back through the database management system 12 where it is routed to a remote receiving appliance 16 either directly, or through the host communications interface 10.

In one embodiment of the present invention the host communications interface 10 is provided with software that recognizes and translates a plurality of machine languages. In another embodiment of the present invention the host communications interface 10 is provided with software that recognizes, translates and formats information received from all commonly used medical devices. The software required to provide the host communications interface 10 of the present invention with universal recognition, translation and formatting capabilities is either commercially available, or written for specific applications by persons of ordinary skill in the computer programming arts. In another embodiment, there are more than one input interfaces. For example, one interface may receive digital format live video (e.g., using a DICOM standard for transmission), another may accept various formats of analog video, another might recognize and translate a plurality of machine languages, and another might provide connection with the Internet or Intranet.

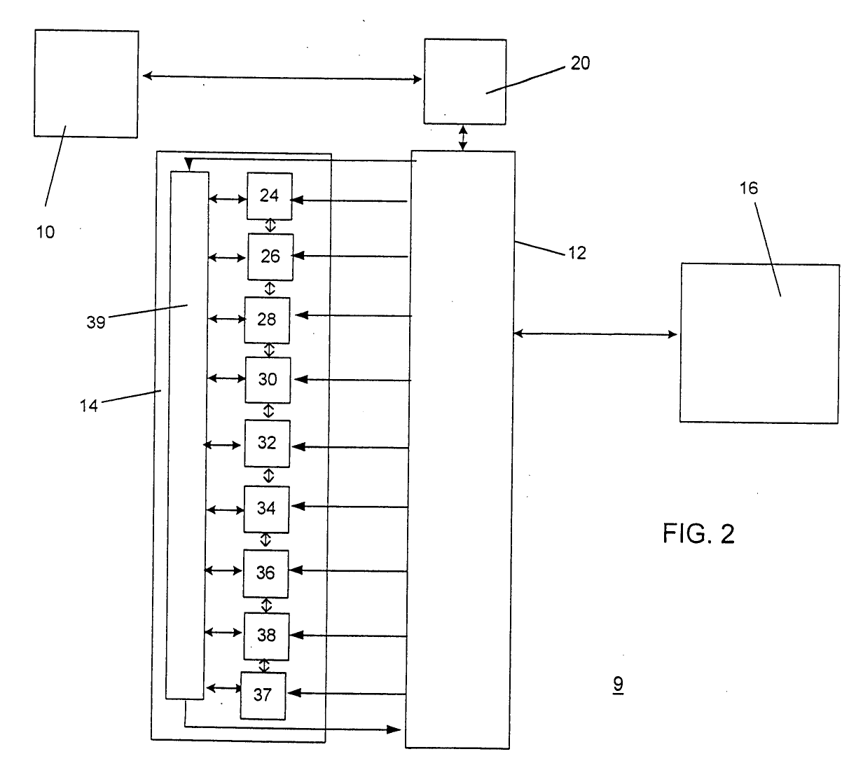

FIG. 2 depicts another embodiment of the present invention that combines a firewall 20 with the host communications interface 10. The firewall 20 provides secure access to the database management system 12 and screens all incoming information for viruses, corrupt files, system intruders and unwanted e-mail solicitations. Additional security functions as known to those skilled in the art can also be provided by the firewall 20. Secure access to the database management system 12 is achieved by a password system as known to those skilled in the art. Additional security features will be described below.

Incoming information is translated, formatted and passed through the firewall 20 to the database management system 12 which is provided with software known in the art for routing the information to the proper database, or databases. Databases of the present invention are divided into a hierarchical scheme divided into first, second, third and higher order databases. Examples of first order databases include, but are not limited to, technical information 24, technical updates 26, marketing information 28, frequently requested information 30, user profiles 32, regulatory updates and advisories 34, investor information 36, and company profiles 38. The database hierarchy is established based on the sequence a user uses to initially access the database. Information contained within all databases is stored on computer readable media, such as a hard disk, floppy drive, CD-ROM, or tape and loaded onto the memory 39 when in use.

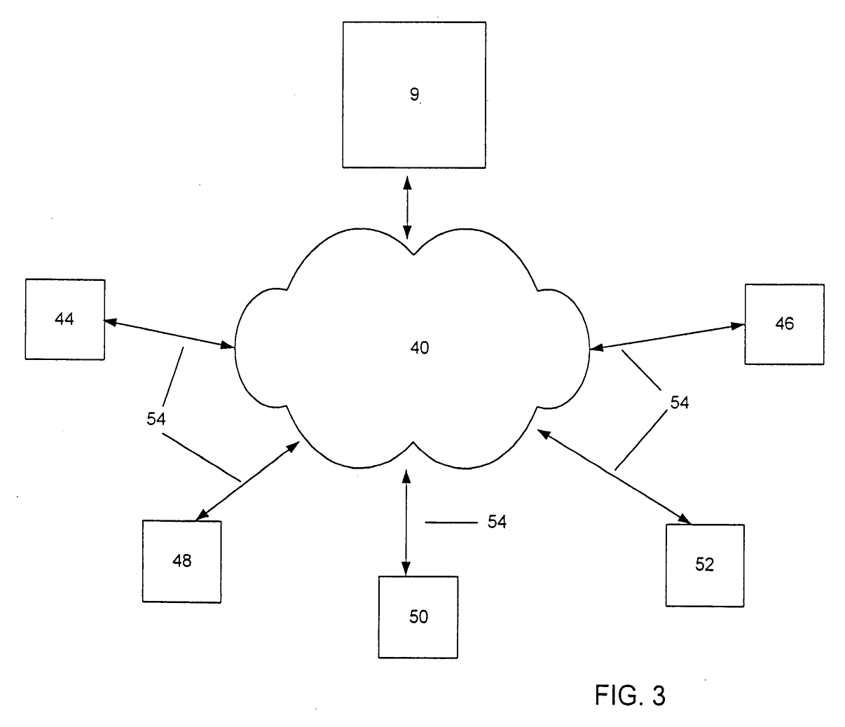

FIG. 3 depicts a bi-directional network 40 of the present invention coordinating the association of multiple remote-transmitting appliances and/or remote-receiving appliances 48, 50, and 52 with the integrated medical information management and medical device control system 9. The remote transmitting and receiving appliances 48, 50, 52 of the present invention include, but are not limited to, computer terminals, devices for monitoring patient status, diagnostic devices, therapeutic devices, portable electronic devices, telephones, radio transmitters, imaging devices or any device capable of accommodating a modem, serial or parallel data transmissions, such as a RS232 port, network card or similar transmission means for transmission of electronic data. FIG. 3 also depicts the bi-directional network 40 linking a remote Internet server 44 and an online service provider 46 to the integrated medical information management and medical device control system 9. Although FIG. 3 depicts a minimal number of links 54 in order to simplify the drawing, there are essentially an unlimited number of links and associations that the bi-directional network can connect to the integrated medical information management and medical device control system 9 of the present invention.

The links 54 to the bi-directional network 40 and communications with the integrated medical information management and medical device control system 9 can be established using any method known in the art. Non-limiting examples include a Local Area Network, a discreet modem connection using a Serial Line Internet Protocol (SLIP) or a Point-to Point Protocol (PPP), an Integrated Services Digital Network (ISDN) an Asymmetric Digital Subscriber Line (ADSL), or a coaxial television cable.

Information can be entered into the transmitting appliances using a variety of input means including, but not limited to keyboards, joy sticks, touch sensitive video screens, bar code readers, push buttons, switches, key punch cards, position sensing devices and microphones. In one embodiment of the present invention the information-input means consists of hands free, voice activated systems whereby verbal commands are spoken into a microphone that relays the signal to a transmitting appliance having voice translation software. The translated signals may consist of operational instructions for the local medical device, or be sent through the bi-directional network communication system to a remote-receiving appliance or to a Web site.

Similarly, receiving appliances translate incoming information from the Web site of the present invention and provide the translated information to the operator. The receiving appliance presents the information to the operator using a variety of display means including, but not limited to video monitors, light signals (e.g., infrared), radio frequency signals, Teletype printouts, Braille printouts, and audible broadcasts. In another embodiment of the present invention telecommunication means and software are associated with the transmitting and/or receiving appliances. The telecommunication means allows for immediate verbal communication between the operator and third parties.

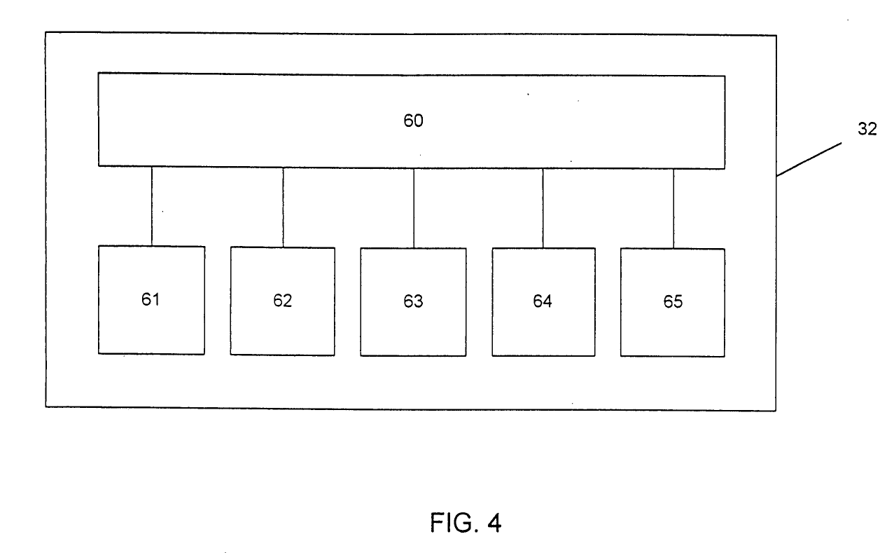

In one embodiment of the present invention a medical service provider (operator) initiates a medical procedure using at least one medical device located in close proximity to a patient. The medical device has a transmitting appliance and a receiving appliance integrated into its chassis, or may be connected to a stand-alone transmitting and receiving appliance such as, but not limited to, dumb terminals, terminal emulation, WebTV, computer terminals, and network computers. At anytime before, or during the medical procedure, the operator may use the transmitting appliance associated with the medical device to establish a connection with the Web site of the present invention using the Internet or other suitable bi-directional network. Once connected to the Internet, and through it the Web site, an authorized user can access any database depicted in FIG. 2 and FIG. 4. Moreover, the Web site of the present invention provides the operator a portal to the World Wide Web that allows access to any publicly available Web site or subscription service to which the operator subscribes.

The operator accesses the Web site of the present invention by transmitting the Universal Resource Locator (URL) address through the Internet link that is received by the host system housing the Web site of the present invention. The Web site of the present invention may be organized in any manner known to those in the art including, but not limited to, a tree structure, a line structure or randomly. Once the connection is established the Web site “home page” is transmitted to the receiving appliance. The operator is asked to enter and transmit a password or other identifying code that is received and by host communications interface 10 (FIG. 2) and transmitted to a firewall 20 (FIG. 2). After the operator is identified and authenticated he is allowed to transmit medical information and medical device operating instructions, or select a first order database 24, 26, 28, 30, 32, 34, 36, and 38 depicted in FIG. 2.

In one embodiment, the device would automatically connect with the Internet when activated. The device would connect to a “home page” for a specific service provider and the home page would be customized for the specific device user or location using previously entered data extracted from the users usage pattern or direct user input of pre-stored data. The device manufacturer is one example of a service provider.

In another embodiment, video and/or audio programs for training, education, or entertainment of healthcare staff or patients would be downloaded from the Internet or Intranet. The data transmission would be stored in the data management system described herein or displayed directly by the device. Both live and stored transmission would allow for direct interaction with other sites using Internet or Intranet. For example, display of a training video shown live or pulled up from data storage would be accompanied by a “live” audio and/or video link to another site for interaction with the trainer.

Turning now to FIG. 4, the operator selects the first order database, user profiles, 32 to initiate the medical device interface with the Web site. A secondary security firewall 60 is encountered that requires the operator to enter a unique personal user identification that allows the operator to proceed. Next, the operator selects from any combination of second order user profile databases desired including, but not limited to a medical device database 61, a patient statistics database 62, and a user preferences database 63. The number of databases that an authorized operator may access within the Web site of the present invention is unlimited. Each time a new database is accessed, it is displayed as a window on the display device of the receiving appliance. Programs for managing the Web site that allows the operator to access and interface with the databases are known to those skilled in the art and are stored in the database management system 12 (FIG 1).

One particularly valuable function of the Web site of the present invention is in assisting the operator with assessing clinical outcome based on a combination of physiological and statistical factors. Physiological factors include vital signs being transmitted to the Web site while the patient is undergoing the diagnostic or therapeutic procedure and the patients pre-existing medical condition. The operator selects a therapeutic procedure option from the menu of the statistical analysis and risk management database 65 and inputs his selection. Physiological factors and patient attributes are extracted by statistical analysis database 65 from the patient statistics database 62 and an algorithm is applied to information to determine what outcome is statistically probable.

Statistical analysis database 65 also serves as a patient monitor alerting the operator of potentially life threatening events. Software is provided to the statistical database 65 that enables the Web site to anticipate potentially life threatening situations before a human operator would notice the threat. This is possible due to the large amount of medical information available to the statistical database 65 and the algorithms contained in the software. In one embodiment of the present invention the Web site can be instructed to override medical devices and/or preempt operator commands if continuing the procedure could injure the patient.

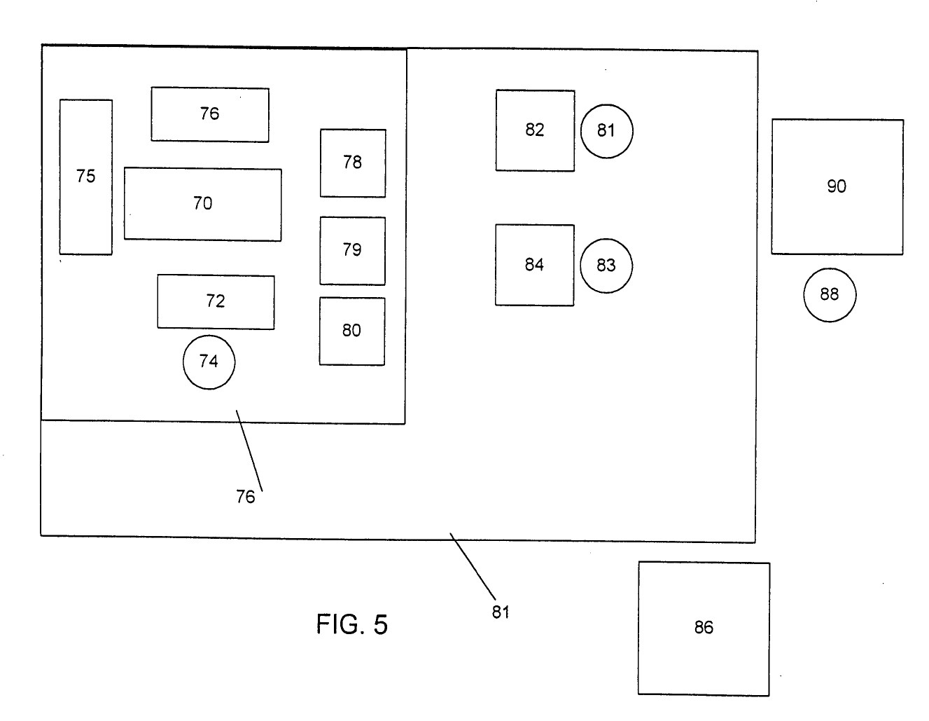

FIG. 5 depicts a non-limiting example of how the present invention can be used to interface multiple medical devices and users simultaneously. Patient 70 is situated in close proximity to medical device 72 and operator 74 that are collectively located within a sterile field 76. For the purposes of this example only, medical device 72 is an angiographic injector system. A non-limiting example of a suitable angiographic injector system is described in pending U.S. patent application Ser. No. 08/966,088, the contents of which are hereby incorporated by reference. Co-located with angiographic injector 72 is a fluoroscope 75 that is providing images of the patient's 70 arteries that are visualized on a fluorescent screen 76.

The fluoroscope 75 is provided with a transmitting appliance that is connected to the bi-directional network 40 (FIG. 3) so that the images displayed on the fluorescent screen 76 are received by the Web site 9 (FIG. 3). The information, including the fluorescent pictures, sent by the transmitting appliance incorporated into the fluoroscope 75 is recognized by the host communications interface 10 (FIG. 2) and firewall 20 (FIG. 2.) of the Web site 9 (FIG. 3). Recognition of the information sent by the fluoroscope and other remote-transmitting appliances is accomplished using software incorporated into microprocessor memories associated with each remote-transmitting appliance. Once received and recognized by the Web site 9 (FIG. 3) the images of the patient's 70 arteries are directed by the database management system 12 (FIG. 2) to the first order database user profiles 32 (FIG. 4) and stored in the second order database patient statistics database 62 (FIG. 4).

An electrocardiograph (EKG) 78, blood oxygen saturation monitor (SAO₂) 79 and a respirometer 80 are connected to patient 70 and to the bi-directional network 40 (FIG. 3). Connections to the bi-directional network 40 (FIG. 3) are accomplished using a transmitting appliance and software as described above for the angiographic injector 72 or by other means known in the art. The electrocardiograph, heart rate, blood pressure, blood oxygen saturation and respiration data (collectively referred to hereinafter as “vital signs”) obtained from patient 70 by the EKG 78, SAO₂ monitor 79 and respirometer 80 are transmitted to the Web site 9 (FIG. 3) of the present invention. The Web site 9 (FIG. 3) receives, processes and stores the patient's 70 vital signs as described generally above.

The operator 74 stationed by the angiographic injector 72 interfaces with the Web site 9 (FIG. 3) of the present invention using a transmitting and receiving appliance either incorporated within the angiographic injector 72 or a stand alone transmitting and receiving appliance such as a personal computer. In the present example, the angiographic injector described in U.S. patent application Ser. No. 08/966,088 is provided with a personal computer-based microprocessor incorporated into its chassis. After the operator 74 establishes a link with the Web site of the present invention 9 (FIG. 3) as described in detail above, he can access the patient statistics that has been previously stored in the patient statistics database. Additionally, the operator 74 can also access the data being transmitted to the Web site by the remote transmitting appliances, including, but not limited to the EKG 78, SAO₂ monitor 79 and respirometer 80.

Consequently, the operator 74 has immediate and simultaneous access to all relevant information pertaining to the patient and the medical procedure in one place. Merely by opening different windows on his display device the operator can see the current angiograph, the flow rates of angiographic fluids being injected, the volumes of angiographic fluid injected and remaining in the reservoir, the patient vital signs, and current laboratory data. Other critical data stored at the Web site of the present invention are available to the operator 74. Moreover, the operator has access to the World Wide Web including any non-restricted Web sites. For example, if the operator wants to obtain a scientific paper from the National Library of Medicine's Web Site, Pub Med, he enters and transmits the appropriate URL (www.ncbi.nim.org). The search window at the National Library of Medicine opens on his screen permitting a publication search while maintaining immediate access to the patient statistics described above.

Furthermore, the operator has access to a select group of medical consultants through the Web site. These consultants are available for immediate, real time consultations. For example, during an angiographic analysis the operator 74 encounters an anatomical structure unfamiliar to him and the attending staff. The operator 74 opens the second order consultants database 64 (FIG. 4) within the user profiles data base 32 (FIG. 4) and requests a consultant 88, or selects from a list of available consultants. The consultant 88 is contacted using telecommunication devices known in the art and is notified that his or her services are requested. The consultant then connects to the Web site 9 of the present invention using a remote transmitting and receiving appliance 90 as previously described. The consultant 88 has immediate and simultaneous access to the same information the operator 74 is presently using. For example, the consultant 88 sees the same angiograph that the operator is viewing and has access to the same vital signs and patient history. The consultant may then either offer the operator her opinion, request further information, or using the remote command and control capabilities of the present invention, take over the procedure from her location. At any point during the procedure other parties, including but not limited to additional consultants, students, and colleagues may join and participate in the procedure or discussion. Each additional party joining the group through the Web site of the present invention would have his or her participation level determined by their password and/or the operator 74.

Moreover, additional information can be sent to the Web site of the present invention and added to the patient database at anytime. For example, a laboratory 86 may have either routine or stat laboratory test results that need to be added to the patient history database. As soon as the laboratory results are received and processed by the Web site of the present invention, the operator, consultants and third parties are notified that the laboratory results are available.

Another feature of the present invention is the ability to have transmitting and receiving appliances placed at remote locations. For example, remote receiving and transmitting appliances 82 and 84 are situated outside the sterile field 76 in the present example. Remote operator 81 or 83 situated at these remote transmitting and receiving appliances can access the Web site of the present invention and participate in the procedure to any level authorized by their passwords or by the operator 74. In the case of an emergency, or to give the operator 74 a break, remote command and control functions can be assumed by remote operator 81 or 83. The remote operator 81 or 83 has complete control of the medical procedure, all medical devices connected to the Web site 9 (FIG. 3) and access to all information available on the Web site 9 (FIG. 4) that the remote operator 81 or 83 have authority to access.

Another feature of the present invention is the operators' 74, 81, 83 ability to access the Web site of the present invention and its contents from any place in the world. Consequently, the pre-established preferences for a particular medical device along with access to consultants and patient histories are immediately available to the operator regardless of his location. This capacity of the present invention allows a medical procedure to be conducted with consistency and reliably at diverse locations.

In another embodiment of the present invention the Web site has the capacity to interface with a medical device so that the medical device is actually controlled automatically by information and preferences the physician has previously transmitted and stored in the Web site's user profiles database 32 (FIG. 2).

In another embodiment of the present invention, the first order data base 24, 26, 28, 30, 32, 34, 36, and 38 depicted in FIG. 2 includes a device service and/or modulating database. This database can be used to upgrade the device operating system. In addition, this database can be used to change the modality of the device. For example, the database can be used to change the injector system disclosed in U.S. patent application Ser. No. 08/966,088 from one used in cardiology to one used in radiology or MRI applications.

In still another embodiment of the present invention the first order database 24, 26, 28, 30, 32, 34, 36, and 38 depicted in FIG. 2 includes a client management database. The client management database contains second order databases that permit client management databases to track supplies, medical procedures and other information related to inventory control and patient billing. The second order databases are unique for each client and confidentiality is maintained by additional firewalls. After a medical procedure is complete, the hospital's inventory is adjusted to reflect the materials used and the patient's account is automatically charged for the procedure, supplies and hospital staff including the attending physician. Consequently, errors in billing and inventory control are minimized resulting is significant cost savings for the hospital or healthcare institution.

In another aspect of the invention, it is important to ensure accuracy of the information being transmitted to and from the website, particularly such information that pertains to patient statistics. One way of ensuring such accuracy is to provide the data to and from the website in a parallel manner and then to compare the data for uniformity before permitting further manipulation or access to the data, for example, for the purpose of device control. In one embodiment, the website would signal to the user that the data is corrupt if the data does not uniform from both parallel paths.

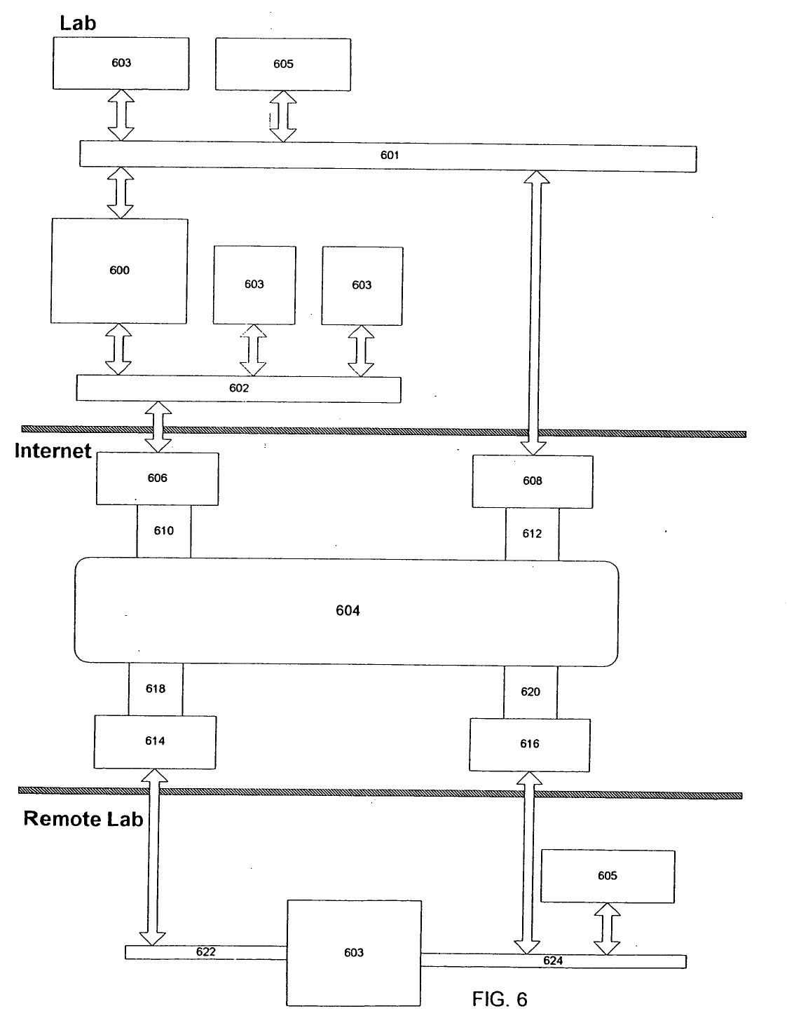

A schematic example of the above-described parallel data management is set forth in FIG. 6. In this embodiment a medical device 600 arranged to interface with two different Large Area Networks (LAN's), 601, 602. Obviously, each LAN can have multiple user interfaces 603, 605. Each of the LANS 601, 602 communicate with the website of the invention through the Internet 604 through two separate routers, 606, 608 and communication ports 610, 612. The website of the invention then conveys the parallel information to two separate remote LANS 622, 624 through two separate routers, 614, 616 and communication ports 618, 620. Provided the data from both routes is uniform, the user is then enable to access, view, respond and otherwise manipulate the data.

During the transmission of the data through both routes, the data may periodically be compared. For example, the comparison can be performed at the source of the data as it is being transmitted to the LANs 601 and 602. It can also be compared at the website of the invention. Alternatively or supplementally, it can be compared at the remote user site.

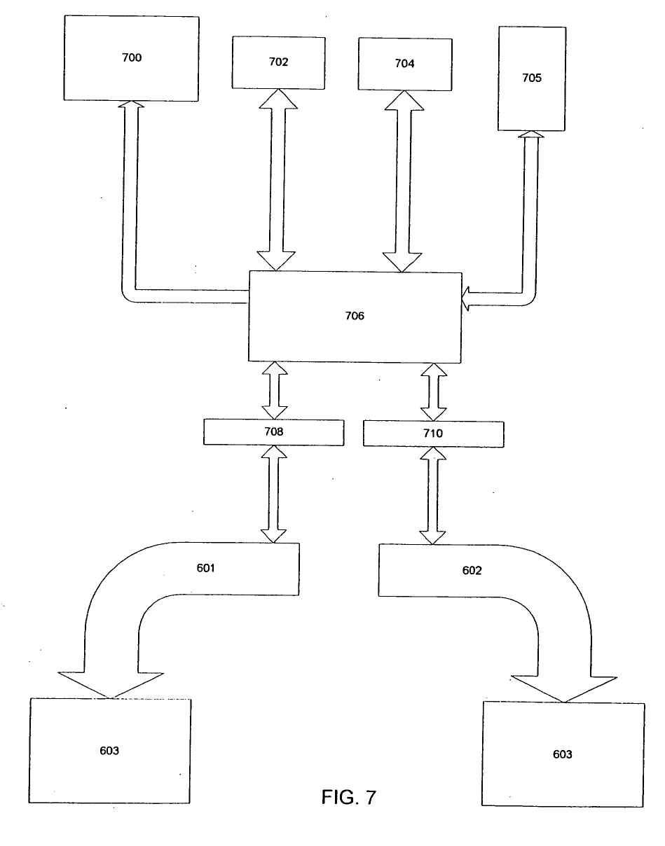

Referring to FIG. 7, a schematic is provided showing the medical device 600 and its associated accessories, namely, a display 700, a touchscreen 702, a keyboard 704 and other related interfaces 706 that input into the processor/encoder/decoder device 706. The processor 706 then sends out the data in parallel form to two different routers 708, 710 to the respective LANs 601, 602 which are also shown in FIG. 6.

The preceding examples have been provided to aid the reader in understanding the present invention and are not intended to limit the scope of the invention. It is understood that that there may be many other configurations and means for providing the same service using the integrated medical information and management system of the present invention. It is apparent that while a preferred embodiment of the invention has been shown and described, various modifications and changes may be made without departing from the true spirit and scope of the invention.

What is claimed is:

1. A medical information management and medical device control system comprising:
(a) at least one transmitting appliance for sending medical information and medical device operating instructions to a host system through a bi-directional network;
(b) at least one receiving appliance for accepting said medical information and said medical device operating instructions from a host system;
(c) a host system comprising:
(1) a host communications interface for receiving said medical information and said medical device operating instructions from said at least one transmitting appliance and for transmitting said medical information and said medical device operating instructions to said at least one receiving appliance;
(2) a database management system,
(3) databases for storing said medical information and/or said medical device operating instructions sent by said at least one transmitting appliances and received by said host communications interface;
(d) a bi-directional network connected to said at least receiving appliance, to said at least one transmitting appliance and to said host communication interface for communicating said medical information and said medical device operating instructions between said host communication interface, said at least one receiving appliance, and said at least one transmitting appliance.

2. The medical information management and medical device control system of claim 1 wherein said medical information and said medical device operating instructions are selected from the group consisting of medical device operational parameters, personal system preferences, technical updates, research articles, patient vital signs, imaging data, medication schedules, laboratory results, patient histories and e-mail.

3. The medical information management and medical device control system of claim 1 wherein said bi-directional network is an Internet or Intranet.

4. The medical information management and medical device control system of claim 1 wherein said bi-directional network is a hard-wired network.

5. The medical information management and medical device control system of claim 1 wherein said at least one transmitting appliance is selected from the group consisting of computer terminals, devices for monitoring patient status, diagnostic devices, portable electronic devices, telephones, and radio transmitters.

6. The medical information management and medical device control system of claim 1 wherein said at least one receiving appliance is selected from the group consisting of computer terminals, devices for monitoring patient status, diagnostic devices, portable electronic devices, and telephones.

7. The medical information management and medical device control system of claim 1 wherein said at least one transmitting appliance has an information input means selected from the group consisting of keyboards, mice, trackballs, light pens, joy sticks, touch sensitive video screens, bar code reader, push buttons, switches, key punch cards, position sensor and microphones.

8. The medical information management and medical device control system of claim 1 wherein said at least one receiving appliances have an information display means selected from the group consisting of include video monitors, light signals, Teletype printouts, Braille printouts, and audible broadcasts.

9. The medical information management and control means of claim 6 wherein said devices for monitoring patient status are selected from the group consisting of an electrocardiograph, a blood oxygen saturation monitor, x-ray imaging, magnetic resonance imaging, magnetic resonance spectroscopy, ultrasound imaging and a respirometer.

10. The medical information management and control means of claim 1 wherein said diagnostic device is an angiographic injector system.

11. A medical information management and medical device control system comprising a World Wide Web site comprising:
a) one or more communication interfaces containing software for:
(1) receiving and translating medical information and medical device operating instructions form a plurality of diverse medical devices which allows said plurality of diverse medical devices to communicate with one another and to communicate with a receiving appliance;
(2) transmitting said medical information and said medical device operating instructions received from said plurality of diverse medical devices to said receiving appliance;
(3) receiving and translating said medical information and said medical device operating instructions form a plurality of diverse medical devices and routing said medical information and said medical device operating instructions to said databases for processing and storage;
(4) receiving and translating said medical information and said medical device operating instructions form a third party and routing said medical information and said medical device operating instructions to said databases for processing and storage;
(5) receiving requests from an operator of a medical device and routing said request to said databases;
(6) receiving and transmitting said medical information and said medical device operating instructions extracted from said databases in response to said request received from said operator; and
(7) receiving and transmitting said medical information and said medical device operating instructions necessary for the remote command and control of the medical device in response to instructions from said operator;
b) a plurality of user accessible databases containing:
(1) information related to coordinating the operation of multiple, diverse medical devices that are used simultaneously in the treatment or diagnosis of a patient in need thereof;
(2) technical information pertaining to the operation and maintenance of a medical device;
(3) answers to frequently asked questions regarding the operations of the medical device; and
(4) a user profiles database containing a series of sub-databases; and
c) a portal to other World Wide Web sites.

12. The medical information management and medical device control system comprising a World Wide Web Site of claim 11 wherein said user profile sub-databases are selected from the group consisting of: medical device database, and user preferences database.

13. A method of managing medical information and controlling medical devices comprising the steps of:
a) providing a World Wide Web site comprising:
(1) a communication interface;
(2) a plurality of user accessible databases comprising:
(A) information related to coordinating an operation of multiple, diverse medical devices that are used simultaneously in the treatment or diagnosis of a patient in need thereof;
(B) technical information pertaining to the operation and maintenance of a medical device;
(C) user profile information including patient statistics, user preferences, available consultants, and algorithms for risk management;
b) receiving medical information and medical device operating instructions through said communications interface to said World Wide Web site;
c) storing said medical information and said medical device operating instructions in said plurality of databases;
d) extracting requested medical information, medical device operating instructions and other information from said plurality of user accessible databases;
e) transmitting said extracted requested medical information, medical device operating instructions and other information through said communications interface to an operator of a medical device;

14. The method of managing medical information and controlling medical devices of claim 13, including coordinating the operations of a plurality of medical devices and operators simultaneously using said communication interface and said plurality of databases of said World Wide Web site.

15. The method of managing medical information and controlling medical devices of claim 14, including receiving imaging information through connections to imaging devices, including x-ray imaging, magnetic resonance imaging, and ultrasound imaging.

16. The method of managing medical information and controlling medical devices of claim 15, including displaying medical imaging from x-ray sources, magnetic resonance imaging, or ultrasound imaging in combination with data or imaging obtained over the internet.

17. A device that services as a nexus between medical imaging devices, clinical information collection, Internet communication and medical imaging display consisting of a device that:
a) receives diagnostic medical imaging data from one or more sources;
b) provides for collection of clinical information in a sterile field environment wherein the user is within the sterile field;
c) provides a connection to the Internet; and
d) provides a mechanism to display medical imaging data for the user.
